(19) United States
(12) Patent Application Publication
(10) Pub. No.: US 2010/0157942 A1
(43) Pub. Date: Jun. 24, 2010

(54) Method for FMIPv6 Handover in UMTS Network and Apparatus for the Method

(75) Inventors: Yoon Young AN, Daejeon (KR); Boo Geum Jung, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/614,148

(22) Filed: Nov. 6, 2009

(30) Foreign Application Priority Data
Dec. 22, 2008 (KR) 2008-0131731

(51) Int. Cl. H04W 36/00

(52) U.S. Cl. 370/331

(57) ABSTRACT

The present invention is related to FMIPv6 handover method and apparatus for the method in UMTS network. The present invention comprises obtaining lower layer information about a target RNS from a current RNS; obtaining upper layer information about a target core network from a current core network; establishing a tunnel between a current core network and a target core network by using the lower layer information and allocating a target RNS; and after allocation of a target RNS, transmitting a message notifying a target core network of connection to the target RNS and receiving packet data from the target core network. The present invention supports efficient handover in UMTS network by using MIH service and reduces handover delay

### CROSS-REFERENCE TO RELATED APPLICATION

This application claims the benefit of Korean Application No. 10-2008-0131731, filed Dec. 22, 2008 in the Korean Intellectual Property Office, the disclosure of which is incorporated herein by reference.

### BACKGROUND OF THE INVENTION

1. Field of the Invention

The present invention is related to a method for FMIPV6 handover in UMTS network and an apparatus for the method. More specifically, the present invention is related to a method for FMIPV6 handover in UMTS network and an apparatus for the method, the UMTS network enabling fast handover by estimating layer 3 handover based on layer 2 information of UMTS network.

2. Description of Related Art

In the mobile Internet protocol version 6 (MIPv6), if a mobile node detects a new access point, layer 2 handover is carried out, after which layer 3 handover is carried out. Therefore, MIPv6 can prevent network disconnection due to handover delay encountered when a mobile node carries out handover.

FMIPv6 (Fast Mobile Internet protocol version 6) is a method for carrying out layer 3 handover before layer 2 handover is occurred, receiving layer 3 information from a current router based on layer 2 information of a target router to hand over. An access network is subject to a different layer 2 handover procedure depending on the employed technology such as WiFi, CDMA, Wibro, and UMTS, a method that can provide efficient performance by combining a layer 2 handover procedure and layer 3 handover procedure is desired.

In particular, since a fast handover method based on WiFi, CDMA, and Wibro is already defined, an FMIPv6 handover method that can carry out a layer 2 handover procedure in the UMTS network by using media independent handover (MIH) method is required.

### SUMMARY OF THE INVENTION

One object of the present invention is to provide an FMIPv6 method and an apparatus for the method, the method and the apparatus being able to deliver layer 2 handover information through MIH service to obtain efficient performance by combining layer 2 handover procedure and layer 3 handover procedure in the UMTS network.

To achieve the object, the present provides an FMIPv6 handover method in the UMTS network, comprising obtaining lower layer information about a target RNS from a current RNS; obtaining upper layer information about a target core network from a current core network; establishing a tunnel between the current core network and the target core network by using the lower layer information and allocating the target RNS; and after allocation of the target RNS, transmitting a message notifying the target core network of connection to the target RNS and receiving packet data from the target core network.

Also, to achieve the object, the present invention provides an apparatus for FMIPv6 handover in the UMTS network, comprising a communication unit for transmitting and receiving signals; an information storage unit for obtaining lower layer information about a target RNS from a current RNS through the communication unit and obtaining upper layer information about a target core network from a current core network; and a controller for establishing a tunnel between the current core network and the target core network by using information obtained through the information storage unit and allocating the target RNS and receiving packet data from the target core network through the communication unit.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates a UMTS network to which an FMIPv6 handover method according to the present invention is applied;

FIG. 2 illustrates a flow diagram of an FMIPv6 handover method used in the UMTS network illustrated in FIG. 1; and

FIG. 3 illustrates a detailed block diagram of a mobile terminal for FMIPv6 handover in the UMTS network illustrated in FIG. 1.

### DETAILED DESCRIPTION OF THE INVENTION

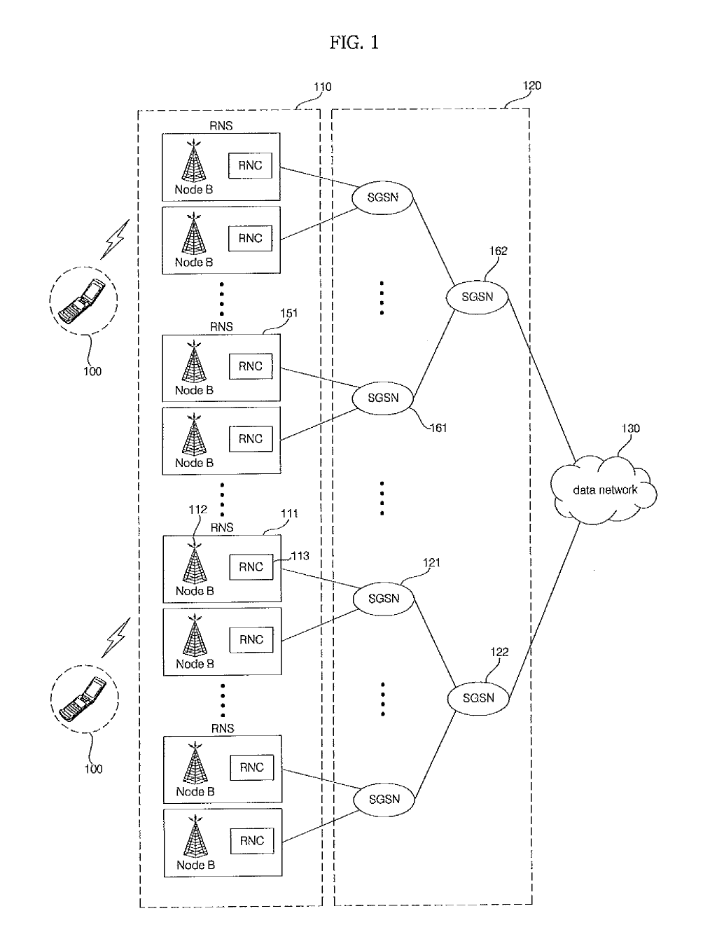

FIG. 1 illustrates a UMTS network to which an FMIPv6 handover method according to the present invention is applied.

As shown in FIG. 1, a UMTS (Universal Mobile Telecommunications System) network comprises a mobile terminal 100, UMTS Terrestrial Radio Access Network (UTRAN) 100, a core network 120, and a data network 130. UTRAN 110 includes a plurality of radio network subsystem (RNS) 111 and the core network 120 includes a serving GPRS support node (SGSN) 121 and a gateway GPRS support node (GGSN) 122.

RNS 111, 151 comprises a node (Node B, 112) and RNS (Radio Network Controller, 113) and carries out the role of an access point. Node B 112 is controlled by RNC 113 and manages physical wireless connection to a mobile terminal 100. RNC 113 manages dynamic resource allocation of wireless resources such as handover in a radio connection network.

SGSN 121, 161 tracks the location of a mobile terminal 100 within service areas and takes care of various tasks such as packet routing and transmission, mobility management, logical link management, authentication, and billing.

GGSN 122, 162 manages a connection function between SGSN 121 and a data network 130 and takes the role of a router. GGSN 122, 162 can transform GPRS (General Packet Radio Service) packets transmitted from SGSN 121 into the form of an appropriate packet data protocol (PDP) and transmit the transformed GPRS packets.

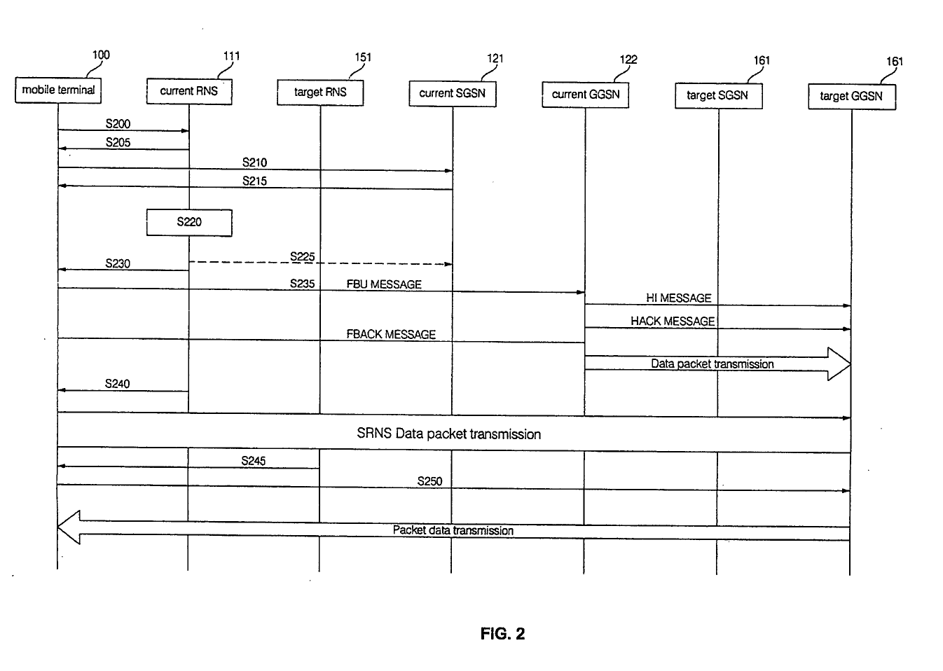

FIG. 2 illustrates a flow diagram of an FMIPv6 handover method used in the UMTS network illustrated in FIG. 1.

As shown in FIG. 2, first, a mobile terminal 100 measures signals of neighboring RNS and transmits information about measured signals to a mobile terminal 100 and a currently connected RNS 111, S200. If a current RNS 111 requests information about measured signals, a mobile terminal 100 transmits a measurement report message to the current RNS 111. A mobile terminal 100 can periodically transmit information about measured signals.

Subsequently, the current RNS 111 detects a new RNS by using information about measured signals, adds an RNS that exceeds performance threshold among newly detected RNSs into a candidate set of RNSs, and transmits information about the RNS that exceeds performance threshold, namely layer 2 information to a mobile terminal 100 by including the information in MIH_Link_Detected message S205.

Next, a mobile terminal 100, to find target GGSN information about RNS included in the information transmitted at S205 step, transmits RtSolPr (Router Solicitation for Proxy) message to a current GGSN 122 and checks layer 3 information about target GGSN by receiving PrRtAdv (Proxy Router Advertisement) message from the current GGSN 122, S215. On the other hand, a mobile terminal 100, by using layer 3 information about target GGSN, can create CoA (Care-of-Address) indicating location information of a network to which the terminal may move. At this point, the current GGSN 122 should be aware of information of a neighboring GGSN and RNS information included in the neighboring GGSN beforehand.

Next, a current RNS 111 determines a target RNS 151 for a new handover by using information about measured signals transmitted from S200 step S220, transmits a handover request message (Relocation Required) to a current SGSN 121 to carry out SRNS relocation procedure, namely layer 2 handover S225, and transmits MIH_Handover_Imminent message to a mobile terminal 100 to notify that layer 2 handover is to be carried out S230.

A mobile terminal 100 establishes a tunnel between a current GGSN 122 and a target GGSN 162 to which a target RNS 151 belongs by using the target RNS 151 identified by MIH_Handover_Imminent message S235. To establish a tunnel between the GGSN 122 and the target GGSN 162, a mobile terminal 100 transmits FBU (Fast Biding Update) message to the current GGSN 122; the current GGSN 122 that received FBU message transmits HI (Handover Initiate) message to the target GGSN 162; the target GGSN 162 that received HI message transmits Hack (Handover) message to the current GGSN 122; the current GGSN 122 that received Hack message transmits FBack (FastBindingAcknowledgment) message to a mobile terminal 100. At this point, if the current GGSN 122 receives FBU message, the current GGSN 122 starts buffering packets received from the corresponding node (CN) and transmits the buffered data packet to the target GGSN 162 after a tunnel is established in response to receiving Hack message.

Next, a current RNS 111 transmits MIH_MN_HO_Commit message to a mobile terminal 100 demanding the mobile terminal 100 to carry out layer 2 handover to a target RNS 151, S240, As MIH_MN_HO_Commit message is transmitted, a target RNS to which a mobile terminal 100 carries out handover can coincide with a target RNS 151 determined by the current RNS 111 at S220 step. As MIH_MN_HO_Commit message is transmitted, layer 2 handover, namely SRNS (Serving Radio Network Subsystem) relocation is carried out and a target RNS 151 is newly allocated to a mobile terminal 100.

Next, if a target RNS 151 is newly allocated to a mobile terminal 100, the target RNS 151 transmits MIH_Link_up message indicating that a link has been upped to a mobile terminal 100, S245.

Finally, a mobile terminal 100 transmits UNA (Unsolicited Neighbor Advertisement) message to a target GGSN 162 indicating connection to a new RNS S250 and layer 3 handover is completed by receiving packet data from the target GGSN 162, S255.

FIG, 3 illustrates a detailed block diagram of a mobile terminal for FMIPv6 handover in the UMTS network illustrated in FIG. 1.

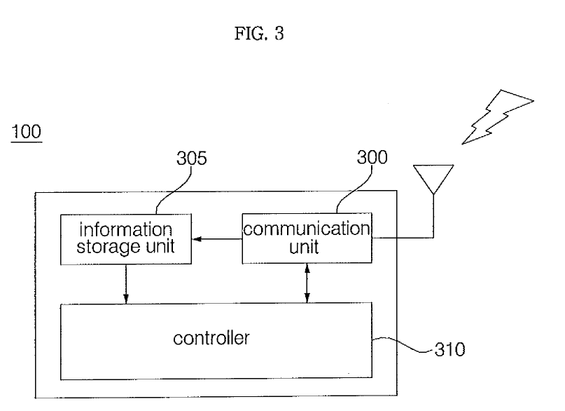

As shown in FIG. 3, a mobile terminal 100 comprises a communication unit 300, an information storage unit 305, and a controller 310.

A communication unit 300 is a module for transmitting and receiving signals, which can receive signals from a current GGSN 122 and a target RNS 151 and transmit signals to a current RNS 111, a current SGSN 121, a current GGSN 122, and a target GGSN 162. The signals can include messages or layer information, which can be in the form of packet data.

An information storage unit 305 stores layer 2 information transmitted from S205 step through a communication 300 and layer 3 information identified at S210 step.

A controller 310 establishes a tunnel between a current GGSN 122 and a target GGSN 162 by using layer 2 and layer 3 information stored in the information storage unit 305, newly allocates a target RNS 151, and receives packet data from the target GGSN 162 through a communication unit 300.

The present invention can be implemented in the form of program codes stored in a processor-readable recording medium. A processor- readable recording medium includes all kinds of recording apparatus to which processor-readable data are stored. Examples of processor-readable recording medium include ROM, RAM, CD-ROM, magnetic tape, floppy disk, and optical data storage. Also, a processor-readable recording medium can be distributed across a computer system connected to a network and processor-readable codes can be stored and executed in a distributed manner.

It will be apparent to those skilled in the art that various modifications and variations can be made in the embodiments of the invention without departing from the spirit or scope of the invention. Thus, it is intended that embodiments of the invention cover the modifications and variations of this invention provided they come within the scope of the appended claims and their equivalents.

What is claimed is:

1. An FMIPv6 handover method in UMTS network, comprising:
obtaining lower layer information about a target RNS from a current RNS;
obtaining upper layer information about a target core network from a current core network;
establishing a tunnel between the current core network and the target core network by using the lower layer information and allocating the target RNS; and
after allocation of the target RNS, transmitting a message notifying the target core network of connection to the target RNS and receiving packet data from the target core network,

2. The method of claim 1, further comprising measuring signals of neighboring RNS and transmitting information about measured signals to the current core network.

3. The method of claim 1, wherein the lower layer information is included in MIH message transmitted from the current RNS.

4. The method of claim 1, wherein the target RNS is allocated through SRNS (Serving RNS) relocation procedure.

5. An apparatus for FMIPv6 handover in UMTS network, comprising:
a communication unit for transmitting and receiving signals;
an information storage unit for obtaining lower layer information about a target RNS from a current RNS through the communication unit and obtaining upper layer information about a target core network from a current core network; and
a controller for establishing a tunnel between the current core network and the target core network by using information obtained through the information storage unit and allocating the target RNS and receiving packet data from the target core network through the communication unit.

6. The apparatus of claim 5, wherein the controller measures signals of a neighboring RNS and transmits information about measured signals to the current core network through the communication unit.

7. The apparatus of claim 5, wherein the lower layer information is included in MIH message transmitted from the current RNS.

8. The apparatus of claim 5, wherein the target RNS is allocated through SRNS relocation procedure.
